(19) United States
(12) Patent Application Publication
(10) Pub. No.: US 2010/0174662 A1
(43) Pub. Date: Jul. 8, 2010

(54) COLLABORATIVE SYSTEM AND PROCESS FOR DEVELOPING AND MANAGING INNOVATIONS

(75) Inventors: Virgilio C. Fabella, JR., Chesterfield, MO (US); Michael Cissell, Eureka, MO (US); Joanne L. Cuddeback, St. Louis, MO (US); Steven M. Gallant, Chesterfield, MO (US); Mark Peterman, Chesterfield, MO (US)

Correspondence Address: SENNIGER POWERS LLP, 100 NORTH BROADWAY, 17TH FLOOR, ST LOUIS, MO, 63102, US

(73) Assignee: MARITZ INC., Fenton, MO (US)

(21) Appl. No.: 12/398,709

(22) Filed: Mar. 5, 2009

Related U.S. Application Data
(60) Provisional application No. 61/033,827, filed on Mar. 5, 2008.

(51) Int. Cl. G06Q 99/00; G06F 15/16

(52) U.S. Cl. 705/319; 709/204

(57) ABSTRACT

A system and process for collaborating members of a network. A generation module facilitates the submission of ideas by the members of the network. A development module facilitates the members of the network to provide input to develop the ideas submitted via the generation module. An evaluation module facilitates the members of the network to provide input to evaluate the ideas developed via the development module. An implementation module facilitates the members of the network to implement the ideas evaluated via the evaluation module. The process comprises the phases of submitting ideas by the members of the network; developing by the members of the submitted ideas; evaluating by the members the developed ideas; and implementing by at least one of the members the evaluated ideas.

### FIELD OF THE INVENTION

The present invention generally relates to a system and process for implementing innovation collaboration and, in particular, a system and process which connects individuals, companies and facilities to facilitate the generation of ideas, the development of ideas, the evaluation of ideas, and the implementation of ideas.

### BACKGROUND OF THE INVENTION

Companies pursue innovation to grow revenue and create a competitive advantage. For example, some companies developed external innovation networks to collaborate with contacts, entrepreneurs, and suppliers in order to increase share price, free cash flow, increase profits and market share, increase research and development productivity and provide an increased innovation success rate.

To fully realize the value of innovation, companies need to look beyond their internal resources and engage channel partners, suppliers, customers, individuals, companies, facilities and even competitors. For example, some have announced an initiative around “open innovation,” looking outside for ideas and realizing that it will miss opportunities by relying only on its internal resources. By collaborating on ideas with outside partners, even competitors, products, packaging and business systems improve.

Technology advances are viewed as impacting growth and innovation. Innovation is frequently associated with growth initiatives, which are expected to drive competitive advantage. Many executives believe their companies are more effective on developing growth strategies, and less effective on implementing them successfully and quickly. Other executives believe their companies are less effective on developing growth strategies, and more effective on implementing them successfully and quickly. There is a need to bring these companies and their people together in a unified collaborative framework.

There are many reasons for less effective implementation of growth strategies. For example, there are barriers to innovation and a need for ways to overcome the barriers. Some of the barriers to innovation include ineffective collaboration in that the quality of collaboration is minimal, incomplete collaboration in that insufficient people participate in the collaboration process; lack of incentives to participate in the process; incomplete collaboration processes; and/or insufficient management of the collaboration process.

There is a need for systems and process which facilitate innovation by: improving internal and external collaborations; offering incentives which drive innovative solutions; providing an end-to-end process for bringing an idea to market; and/or encouraging more management focus on innovation.

Today, almost every company is communicating innovation messages in the media and to analysts. There is a need for a system and process which further promotes, enhances, develops, manages and executes such technology collaboration and assists in overcoming at least some of the above noted barriers.

### SUMMARY OF THE INVENTION

In one form, the invention is a solution for collaborating members of a network by providing an online tool for collaborating on innovation ideas, and by providing an end-to-end process to submit, develop, and evaluate innovation ideas. Where there are gaps, the invention also provides or makes available products and services to remedy these gaps.

This solution may be implemented as a system or process which includes four modules. In the first module, referred to as a generation module, ideas are submitted by the members of the network. The second module is a development module where the members of the network provide input to develop the ideas submitted via the generation module. In the third module, an evaluation module, the members of the network provide input to evaluate the ideas developed via the development module. Finally, an implementation module is used for facilitating the members of the network to implement the ideas evaluated via the evaluation module.

In another form, the invention is a process for collaborating members of a network comprising four phases. First, ideas are submitted by the members of the network. Second, the members develop the ideas submitted. Third, the developed ideas are evaluated by the members. And fourth, the evaluated ideas are implemented by at least one of the members.

Objects and features will be in part apparent and in part pointed out hereinafter.

### BRIEF DESCRIPTION OF THE DRAWINGS

FIG. 1 is a graph illustrating the relationship between the degree of collaboration and the relative intrinsic value of innovation.

FIG. 2 is a graph illustrating the relationship between time and key business results (KBR) for an innovative idea.

FIG. 3 is a block diagram illustrating the revenue model of the system and process of one embodiment of the invention.

FIG. 4 is a block diagram illustrating the innovation experience roadmap according to one embodiment of the invention.

FIG. 4A is a block diagram of a modular implementation of one embodiment of a system of the invention.

FIG. 5 illustrates the interaction between the system and process according to one embodiment of the invention and the innovation experience roadmap of FIG. 4.

FIG. 6 illustrates an example of how the system and process permit a choice between targeted collaboration innovation and collective collaborative innovation to address an innovation gap in an automotive environment.

FIG. 7 illustrates an example of how the system and process of the invention uses assessment and program design, and rewards and recognition within the context of the innovation experience roadmap to address an innovation gap in a pharmaceutical environment.

FIG. 8 shows collaborative innovations programs which are implemented by the system and process of the invention and which may result in residual income to the system administrator.

FIGS. 9 and 9A are a flow diagram of the operation of the system and process according to one embodiment of the invention.

FIG. 10 illustrates one embodiment of the solution of the invention which is based on tiers which can be implemented one at a time.

FIG. 10A illustrates one embodiment of infrastructure for the solution of the invention illustrated in FIG. 10.

Corresponding reference characters indicate corresponding parts throughout the drawings.

### DESCRIPTION OF THE PREFERRED EMBODIMENTS

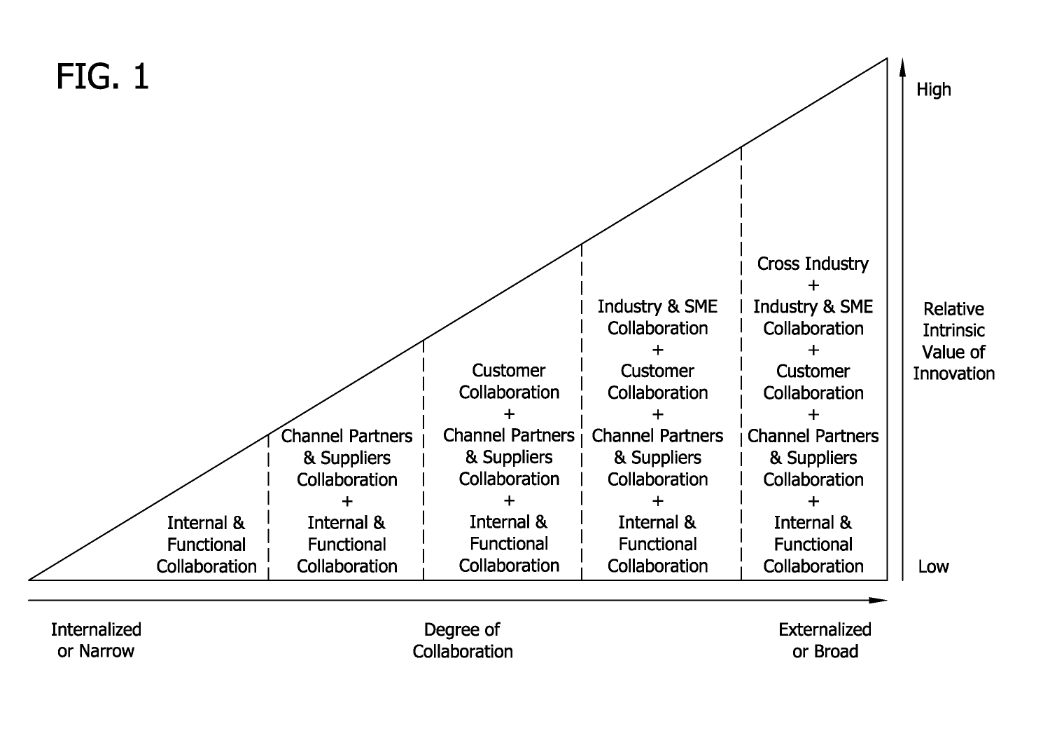

One aspect of the present invention is directed to increasing the degree of collaboration so that the relative intrinsic value of innovation is increased, as shown in FIG. 1. The ability and desire of a company to effectively collaborate internally and externally creates the critical path to achieving revenue growth and competitive advantage through collaborative innovation. The system and process of the invention facilitates this critical path. In particular, the system and process of the invention provide a flexible platform and process which can take many shapes or forms depending on such aspects as the needs of platform manager, the requirements of the collaborators, the degree of collaboration required, the information and/or idea being collaborated, the intrinsic value of the innovations involved in the collaboration, and/or the implementations of the information. Associated with the degree of collaboration and intrinsic value of innovation, this invention in one embodiment through the use of member profiling, identifies members within and throughout each segment, e.g. internal and functional collaborators, channel partners, individuals, companies, facilities and supplier collaborators, etc. User or member profiling includes identifying members for collaboration based on at least one of rational and/or irrational member characteristics and/or based on identifying key facilitators of ideas. In general, not all members of the system are involved in a particular collaboration. In addition, non-members can be invited by other members, the program administrator and/or the idea owner to participate and/or to become members. Identification of these key facilitators enables the efficient and targeted collaboration of innovation ideas within and throughout each segment.

For example, certain embodiments of the system and process will be able to provide one or more of the following: public and/or private collaborative innovation; an end-to-end process for collaborative innovation management (idea solicitation through implementation); reward models that reinforce continued participation; push and pull technology which increases community connection points needed to leverage Social Networking; and a plug-in that transforms web-based blogs, forums, social networks, and private portals into a true interactive and collaborative innovation portal.

In one embodiment, implementation allows a subnetwork of collaborators and/or brokers within the social network to drive and define a particular process with regard to a particular idea or project. In this regard, the collaborators and/or brokers can direct pursuit depending on the challenges that should be pursued and depending on the results that are desired.

In the network embodiment illustrated in FIG. 1, the system further differentiates from other innovation solutions by allowing members of the network or process to set, re-set, and extend collaboration to their value chain. The value chain includes customers, channel partners, individuals, companies, facilities, and suppliers, industry and subject matter experts (SME), and others across industries which are connected to an idea owner, a member, and/or a particular technology. Where most solutions stop at internal and functional collaboration and direct value chain, the system and process of the invention allows innovation ideas to gain additional residual value by extending collaboration to channel partners and suppliers, customers, industry and SME, and across industries, thereby including the indirect value chain. As FIG. 1 illustrates, the relative intrinsic value of innovation or an idea under collaboration increases with increased value chain participation.

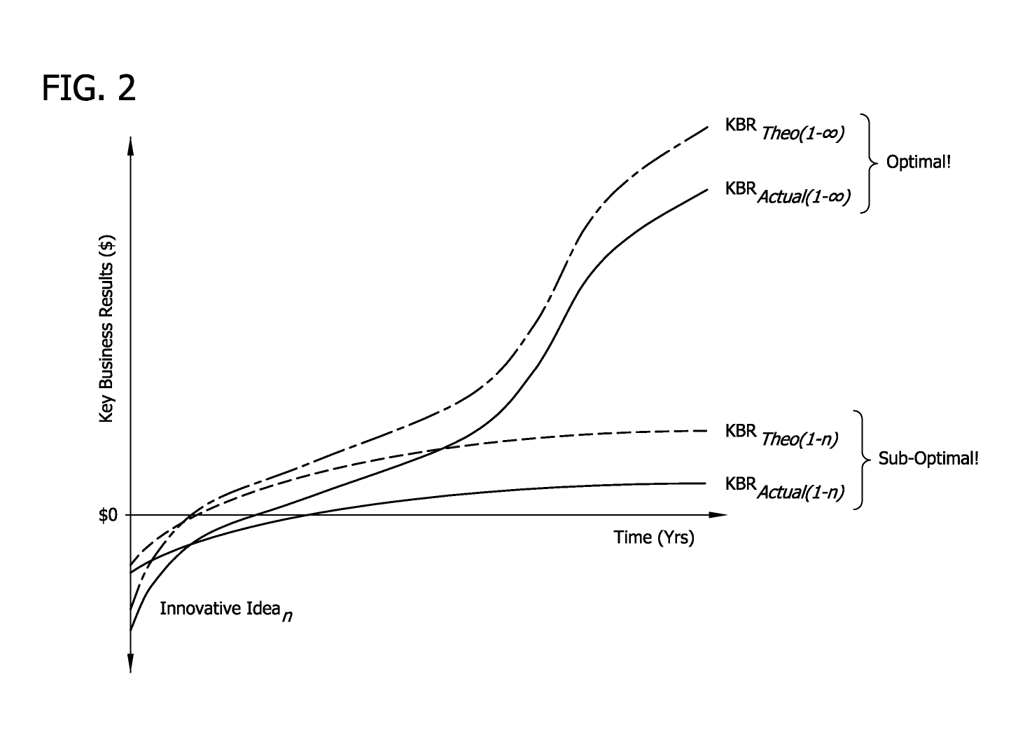

Broad and externalized collaboration within direct and indirect value chain members tends to yield the type of optimal key business results illustrated in FIG. 2. On the other hand, internal collaboration tends to yield the type of sub-optimal key business results illustrated in FIG. 2.

The technical components of the system and process of the invention accomplish a business intelligence solution with at least one or more of the following features: a data model, basic and advance analytics, reporting, advance search, and knowledge management.

The data model of the system and process of the invention is a description of how data is structured and used in the collaboration process and system of the invention. In the case of a “comprehensive data model”, the data model must encompass data that will be relevant to such industries as pharmaceutical, automotive, technology, telco, finance, and/or banking. There are several data models available, e.g. hierarchical, relational, star schema, etc. For example, a star schema may be the model used in one embodiment of the system and process of the invention simply because it is the simplest style of data warehouse schema.

Basic analytics may be used with the system and process of the invention to provide a simple relational statistical analysis and mining of data provided to the members participating in the collaboration. On the other hand, advanced analytics may be used to provide complex and/or multidimensional statistical analysis and mining of data to the members.

The reporting of the system and process of the invention builds on these basic and advance analytics and permits the generation of reports reflecting the data and its statistical analysis. The members use these reports to further advance the collaboration process.

Advance searching provides the ability to search the data repository (data warehouse, data mart, or operational database) using one or more parameters beyond key words.

Knowledge management in this context means a technical process of creating and sharing business insight or business interpretation of data captured and stored. In other words, data can have explicit and implicit definition. In knowledge management, the focus is not only the explicit definition, but also the implicit definition either in combination with another data or groups of data.

In one embodiment, the system and process of the invention provides a portal and collaboration engine which facilitates collaboration in two useful manners. First, the engine promotes sharing of data, information, and knowledge. Second, the engine allows for meetings, including virtual reality experiences, and calendaring for meetings which facilitate input and evaluation, further facilitating the advancement of the collaboration process.

The technical infrastructure of the system and process of the invention may include hardware, software, authentication and authorization security management, integration services, disaster recovery, and networking. Optionally, the system and process may provide potential Social/Networking Partners Integration such as integration with Linked In, Facebook, Del.icio.us, Google, Yahoo, MSN, MySpace, etc. This integration allows the collaborative innovation process system to be extended to other social network sites. For example, in one embodiment, a formal partnership agreement (that covers intellectual property rights and abiding by the business rules within solution of the invention) would be arranged with these sites, so that the solution of the system and process of the invention may be extended to members of these sites.

FIG. 1 illustrates that the relative intrinsic value of an innovation increases as the degree of collaboration increases. In general, limited internal and functional collaboration of an innovation, such as within one entity, provides a relatively low level of intrinsic value to the innovation. Adding channel partners, individuals, companies, facilities and suppliers to the collaboration of the innovation, as permitted by the system and process of the invention, tends to increase the intrinsic value of the innovation. Adding customers to the collaboration of the innovation, as permitted by the system and process of the invention, tends to additionally increase the intrinsic value of the innovation. Expanding the collaboration of the innovation to include industry representatives and subject matter experts (SME), as permitted by the system and process of the invention, further increases the intrinsic value of the innovation. Finally, the relative intrinsic value of the innovation is maximized, according to the system and process of the invention, by collaborating with cross industry representatives in addition to industry representatives, SME, customers, channel partners, individuals, companies, facilities and suppliers. In one embodiment, it is contemplated that each member is independent and distinct from the others, each member operates independently and each member has a unique skill set as compared to the skill set of the others.

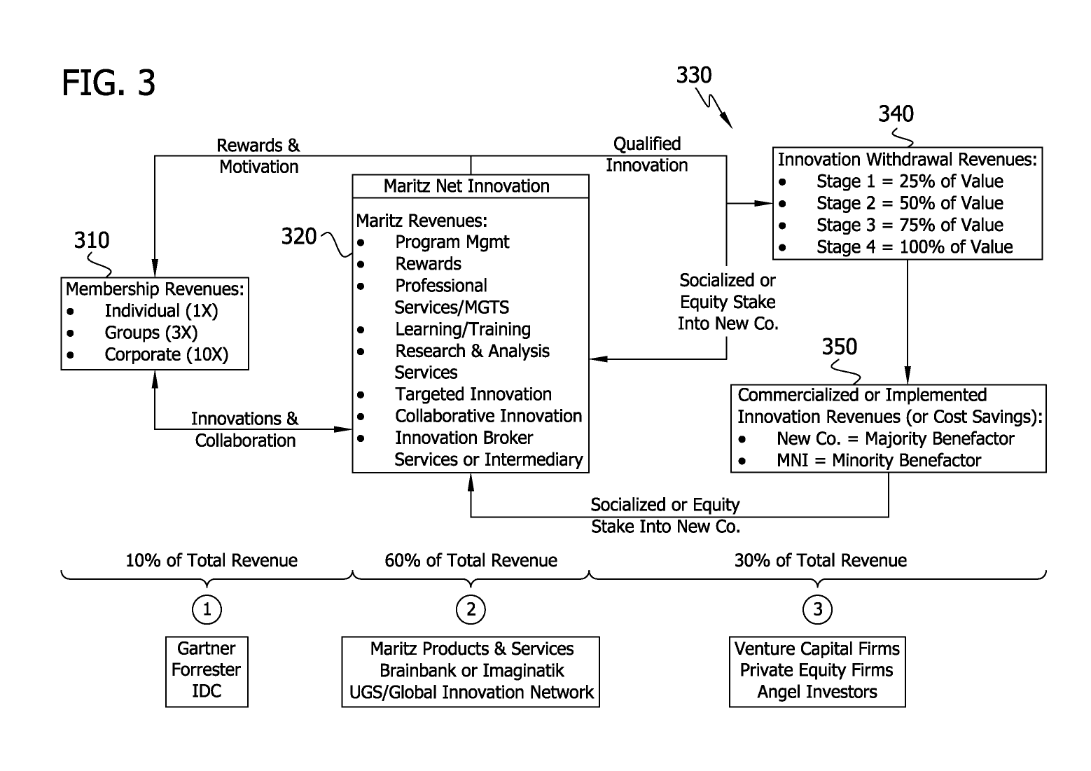

FIG. 3 illustrates one embodiment of a revenue model from the perspective of the system administrator of the system and process of the invention. The model includes three components: a membership module 310, a collaboration module 320 and an implementation module 330 (which includes revenue withdrawal 340 and/or commercialization 350). In general, as used herein, a module may implemented by a separate server for each module or an integrated processor executing all modules. A user interface allows members to interact with each module.

The membership module 310 creates revenue from the registration of individual members, group and/or corporate members. The membership module 310 may be implemented so that it mirrors existing business models including models currently in practice with firms such as Gartner, Forrester, IDC, or other membership-for-a-fee business models. In one embodiment, registration fees for a corporate member may be 10 times the fee for an individual and registration fees for a group member may be three times the fee for an individual.

The collaboration module 320 creates revenue from program management, rewards for contributions or ratings, providing professional services and/or management (either directly or through subcontractors), providing technical services, providing learning and/or training, assisting in research and analysis (either directly or through subcontractors), targeted innovation (see below), collaborative innovation, and providing innovation broker services or an intermediary service.

In one embodiment, collaborative innovation may be an important aspect of the solution of the invention within the innovation development process. For example, collaborative innovation may be viewed as an informal approach of engaging (proactively and/or passively) other members, groups, or corporations in the innovation creation, development, and implementation process. These collaborators can be a member of the hierarchical and/or functional corporate structure of the innovation initiator; or a completely nonpartisan and unrelated collaborator just interested and given the authorization to engage in the collaborative innovation process.

The collaboration module 320 may be implemented to build upon existing business models, such existing systems available from such companies as Maritz, Brainbank, Imaginatik, USG or Global Innovation Network. Alternatively, the collaboration module 320 may be customized to be unique to the solution of the invention. Compared to the other systems, the invention will be a single solution that can accommodate multiple corporate entities, an infinite number of individuals and groups. It is also contemplated that the revenue model can mirror or build on existing business models, e.g. Maritz IdeaSystem, BrainBank, Imaginatik, UGS, etc. By providing rewards and motivation, the collaboration module 320 encourages membership which in turn encourages the input of innovations and collaborations by the members into the collaboration process implemented by module 320. As another example, the implementation module 320 may generate revenue by implementing the payment of collaborators by an idea owner or by an implementer of a collaborated idea. The system or process owner could derive revenue as a percentage of such payments.

The revenue model of the invention may be independent of the system and process of the invention or it may be integrated therewith. For example, the implementation module 330 may create revenue from the revenues generated by the withdrawal 340 of innovations from the system by members and/or by the commercialization 350 of innovations by members. In one embodiment, the implementation module 330 may be implemented to mirror existing business models, e.g. Venture Capital Firms, Private Equity Firms or Angel Investors.

The system and/or process of the invention in one embodiment (referred to herein as MNI or Maritz Net Innovations) will be a virtual collaborative innovation solution for authenticated and authorized business Members to do many things, including: contribute ideas, jointly develop and evaluate those ideas, reward and recognize those members that collaborated, and broker and/or market some or all of the innovation ideas.

As illustrated in section 1 of FIG. 3, the membership module 310 may generate up to 10% or more of the revenue of the system and process and has many benefits. In this embodiment, MNI would be an independent, commercially available system and process, functioning as a repository of industry challenges and compelling innovation ideas. Innovation ideas can be submitted by any member and a request for information can be sent out to other members or globally. Members or invitees could access the system or get involved in the process in order to collaborate on both “open” innovation ideas and on industry challenges. One incentive to get members involved could be that members may qualify for rewards and other recognition for their collaboration. During the collaboration, members may view a “15 Minute Virtual Conference” on an innovation idea. Finally, members benefit by having access to research services, analysts, and “Ask an Expert.”

In one embodiment, it is contemplated that at least four annual membership models may be employed: Individual Membership, Group/Affiliate Membership, and two levels of Corporate Membership. Group/Affiliate Membership accommodates up to 1,500 members. And the first level of Corporate Membership accommodates up to 25,000 members, while the second level accommodates up to 50,000 members.

As illustrated in section 2 of FIG. 3, the collaboration module 320 may generate up to 60% or more of the revenue of the system and process. This section 2 provides products and services revenue including:
Rewards—online catalog access, exclusive certificate offerings, reward collection and/or other services for Top Achievers.
Innovation Broker Services—Confidential Request for Information (RFI) services, venture capital (VC) funding services, entrepreneur/collaborator matching services, and innovation/collaborator matching services.
Program Management—services related to program assessment and design, leadership, communication, and launch activity.
Learning/Training—Advance Role preparation, Reference and Training Manuals, and Leadership/Employee Alignment Sessions.
Research and Analysis—primary and/or secondary research services, and advance analytics and reporting.
MGTS/Professional Services—technical and business consulting services related to custom user interface development or portal development, advance content management, and application and/or security integration.

As illustrated in section 3 of FIG. 3, the implementation module 330 may generate up to 30% or more of the revenue of the system and process and involves:
Innovation Ideas Withdrawal Revenues 340—based on a calculated and predetermined valuation of innovation ideas developed during submittal, revenue from innovation ideas sold for commercialization or implementation will be socialized to all collaborators (less MNI management fees).
Commercialized or Implemented Innovation Revenues 350—based on a calculated and predetermined valuation of innovation ideas developed during submittal, a % of the sales revenue resulting from commercialized or implemented innovation idea will be socialized to all collaborators (less MNI management fees).

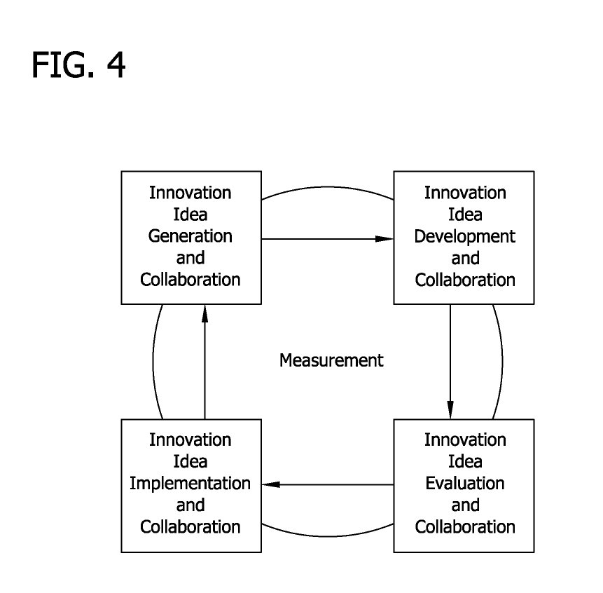

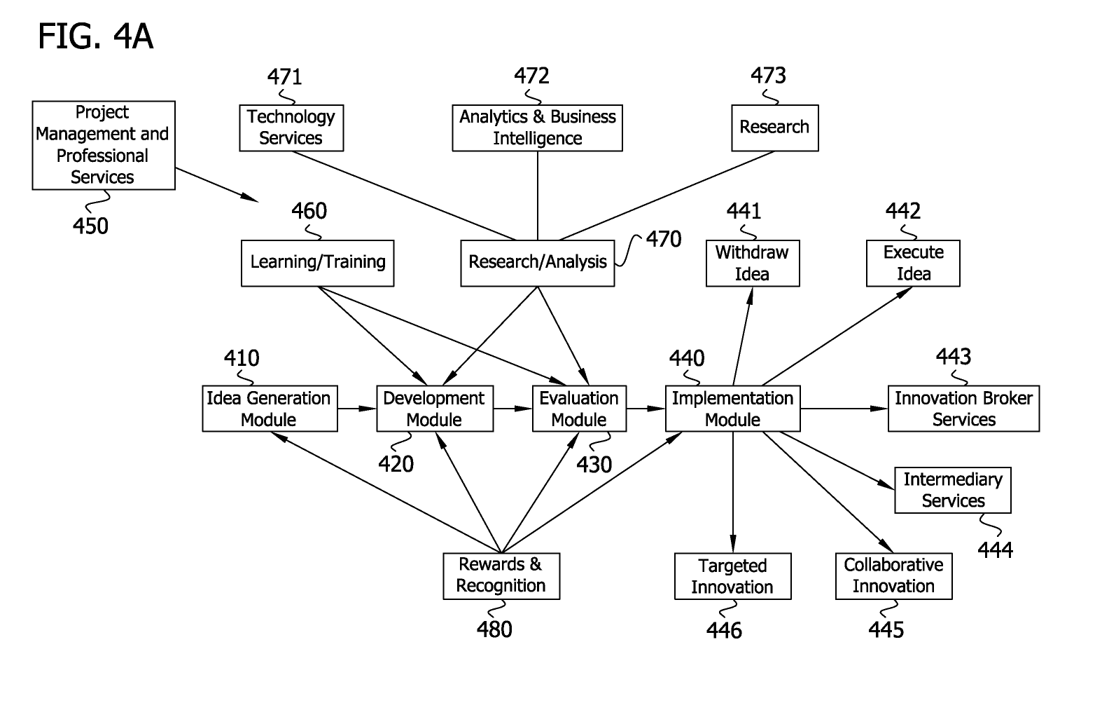

FIG. 4 illustrates an innovation experience roadmap of the system and process according to one embodiment of the invention. The purpose of the system and process includes assisting members of the collaboration network in fully understanding and developing proposed innovations. This enables them to respond to the innovations and add value and further development of the innovation. It also motivates them to get involved in innovations of others as well as letting others get involved in their innovations.

The system and process assess and understand that members have “points of pain” or roadblocks which inhibit motivation to collaborate. Thus, the system and process directs members to focus on one or more of the four (4) phases noted in FIG. 4, depending on the member's skill, business and availability, in order to truly realize the value of innovation and the benefits of a culture of collaboration. The four phases may be implemented sequentially or simultaneously. Initially, a member accesses the system via a user interface and presents an innovation or an idea. Thus, the generation and collaboration phase begins. This leads to other members contributing to this phase or to the development phase, during which the presented innovation or idea is developed thorough collaboration. Both the innovation/idea and the development are evaluated during the evaluation phase, which in turn leads into the fourth implementation phase. Generally, implementation will yield new innovations or ideas initiating the first phase again for a newly yielded innovation or idea. Thus, the process builds on itself, encouraging participation and involvement of the members.

The system and process of the invention provides members with a unique combination of products and services that address gaps within the Innovation Experience Roadmap and facilitate real-time co-creation of wealth and value.

As illustrated in FIG. 4A, the system of the invention in one embodiment may be implemented by modules.

The system for collaborating members of a network includes an idea generation module 410 for facilitating the submission of ideas by the members of the network. As used herein an idea would include a design, a suggestion, a problem to be solved and/or product or process for implementation. A development module 420 facilitates the members of the network to provide input to develop the ideas submitted via the generation module 410. The evaluation module 430 facilitates the members of the network to provide input to evaluate the ideas developed via the development module 420. An implementation module 440 facilitates the members of the network to implement the ideas evaluated via the evaluation module 430.

In addition, optional features may be integrated into the system, some or all of which could be provided by the system administrator or other members. For example, project management and professional services 450 may be optionally provided by a separate module or by one or more of the members. Also, learning/training 460 may be optionally provided by a separate module or by one or more of the members. For example, the system and process may include programmed learning software to instruct a member with regard to a particular technology which relates to an idea being collaborated. In addition, testing and training in a particular technology could be available to qualify a member to be part of a collaboration relating to an idea in the particular technology. Research/analysis 470 including technology services 471 relating to the idea being collaborated, analytics and business intelligence 472 relating to the idea being collaborated and/or research 473 relating to the idea being collaborated may be supplied as an option by a separate module or by one or more of the members. The implementation module 440 may include a process or module to withdraw ideas 441, a process or module to execute or test ideas 442, a process or module to provide innovation broker services 443, a process or module to provide intermediary services 444, a process or module to provide specialized collaborative innovations 445 and/or targeted innovations 446.

For example, the implementation module 430 may provide the program administrator or the idea owner with the functionality to withdraw an idea being evaluated or with the ability to present or encourage executing and/or testing of a particular idea. In this context, ideas for execution or implementation may be prioritized. A module may also link to broker services which would provide access to brokers who could implement, execute or commercialize a collaborated idea. Intermediary services, such as materials cost and handling regarding an idea to be implemented could be available. Certain technologies, such as DNA related sciences, may require specialized collaborative innovations and/or targeted innovations. The evaluation module 430 may also include a module for collaborating by the members with regard to the developed ideas so that multiple members can collaborate on their evaluation. The evaluation module 430 may also include a module for qualifying the evaluated ideas by the members. For example, an idea in a particular technology would have to be qualified by a majority or percentage of members who have expertise in the particular technology. The evaluation module 430 may also include a module for permitting members, idea owners, program administrators, SMEs or others to assign value to the ideas qualified by the members.

Also, rewards and/or recognition 480 may optionally be a part of any or all the modules and/or processes of the system. This module 480 could automatically reward members for participating, such as providing monetary or other incentives, or it could be used by a program administrator or an owner of the idea to reward or recognize or rate the ability of a member for contributing to collaborations.

Thus, in one form, the invention is a process for collaborating members of a network comprising four phases. First, submitting ideas by the members of the network. Second, developing by the members of the submitted ideas. Third, evaluating by the members the developed ideas. And fourth, implementing by at least one of the members the evaluated ideas.

In one embodiment, the system would be a peer-to-peer or server based network which software instructions on a tangible computer readable storage medium for implementing each of the modules and phases noted above. The network would have user interfaces to facilitate member interaction. Member interaction would include members providing or receiving information from or to the system, members interacting via the system or facilitating members to connect directly with each other (not via the system) so that the member interact independent of the system.

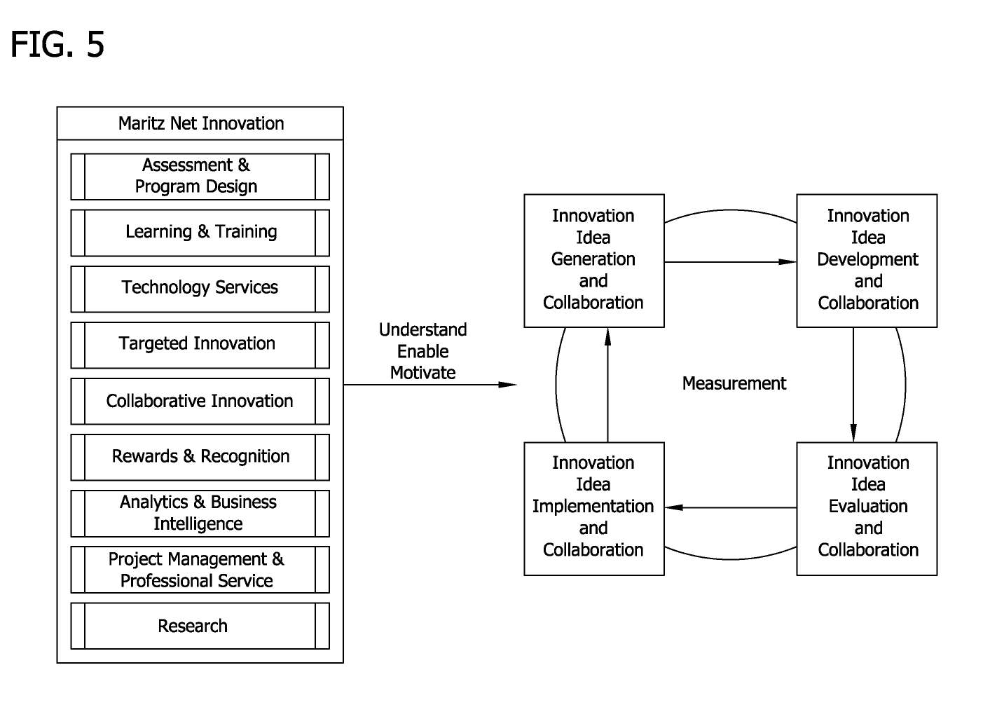

FIG. 5 illustrates the interaction of the system and process of the invention with the roadmap of FIG. 4. One embodiment of the invention, MNI, would implement the four phases of the system and process in a single, integrated system operated by an administrator. Posted ideas would be assessed by members and the administrator would use the assessments to establish a program design. Next, the administrator would implement learning and training of the design and would provide technology services related to the design. Next, the administrator would decide between using a targeted collaboration innovation approach or a collective collaborative innovation approach. In targeted collaboration innovation, individual members are targeted and contacted for participation in the collaboration process. (Although a targeted innovation process has been presented in a general context by the Center for Creative Leadership (CCL), it was not a four-phase approach.) In collective collaborative innovation, a group of members would be invited to participate in the collaboration process. The administrator would have rewards programs and recognition programs available to encourage participation. In addition, the administrator or SMEs would provide an analytical analysis and business intelligence to the process. The administrator could act as a project manager or could arrange for a third party manager with regard to any projects that resulted from the collaboration. The administrator could provide professional services or could arrange for a third party services with regard to any projects that resulted from the collaboration. The administrator could act as a researcher or could arrange for a third party research with regard to any projects that resulted from the collaboration. In context, the administrator would assist members in understanding the process, and in enabling and motivating collaboration.

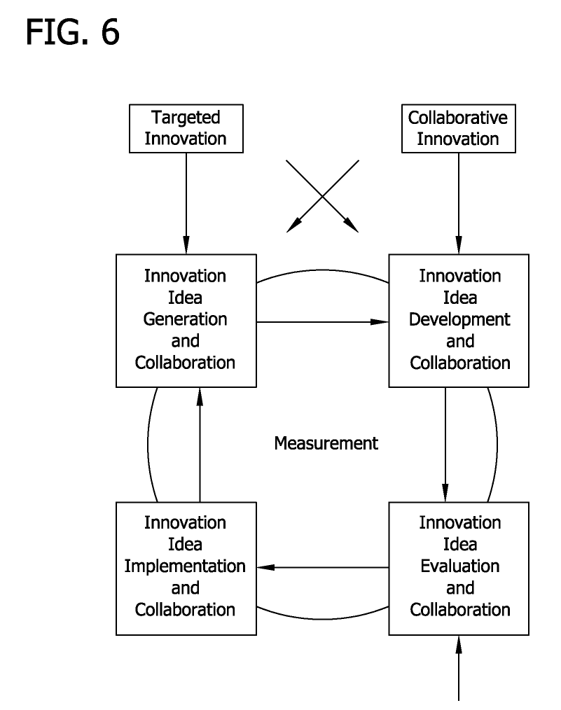

Thus, in one embodiment of the system and process of the invention, both targeted collaboration innovation and/or collective collaboration innovation are available to be implemented either separately, sequentially or simultaneously. FIG. 6 illustrates an example of how the system and process permit a choice between targeted collaboration innovation and collective collaborative innovation to address an innovation gap in an automotive environment. According to the scenario presented in FIG. 6, an automotive company wants to engage its suppliers to generate, develop and evaluate innovation ideas. In general, collective collaboration is open ended to at least some extent and does not significantly limit the members that participate in the collaboration. On the other hand, targeted collaboration is closed ended and limits at least to some extent the members that participate in the collaboration. In this scenario, the automotive company wants to engage its suppliers so that targeted collaboration is the consistent approach.

Within the solution of the invention, targeted innovation may be a component of the combination of products and services that address gaps within the innovation experience roadmap to facilitate real-time co-creation of wealth and value. Compared to other collaborative innovation processes (e.g., organic co-creation of innovation ideas), target innovation is a focused and more organized approach (see below).

In one context, targeted innovation may do many things. It may include a structured, high-energy brainstorming process or be used for a variety of business applications and challenges. Targeted innovation may also employ a team of participants for a half-day (e.g., 8-11) or focus a team on a single, targeted “how to statement.” Further, it may even include a “Client” role on the team, a role that is significant to the success of the session. Finally, targeted innovation may generate hundreds of innovative ideas and solutions with a purposeful emphasis on the quantity of ideas.

At a result, targeted innovation provides the ability to change and/or adjust the user (member) interface themes and business assessment qualification process depending on the “challenge”. For example, the themes and qualification process may include any one or more of the following perspectives: green analysis, product analysis, supplier analysis, customer service analysis, sales analysis, finance analysis, etc. Thus, the solution is to deploy a technology solution that enables real-time external and internal collaboration. Alternatively, targeted innovation may be employed for those ideas which need to be expedited whereas collective collaboration may be employed for ideas that do not require expedited handling.

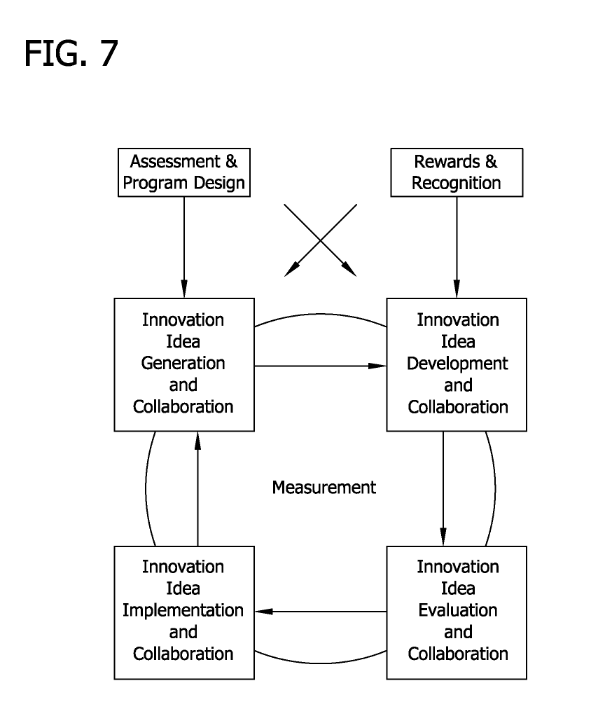

FIG. 7 illustrates an example of how the system and process use assessment and program design, and rewards and recognition to address an innovation gap in a pharma environment. In this scenario, a pharmaceutical company needs to generate and develop new product ideas. The solution is to access, design and deploy a recognition program that reinforces and rewards the appropriate employee behaviors to facilitate the submitting and collaborating of new product ideas. In this instance, the solution of the invention will be able to address the scenario by providing a program with higher rewards structure that entices the employee community to submit and/or collaborate on new product ideas.

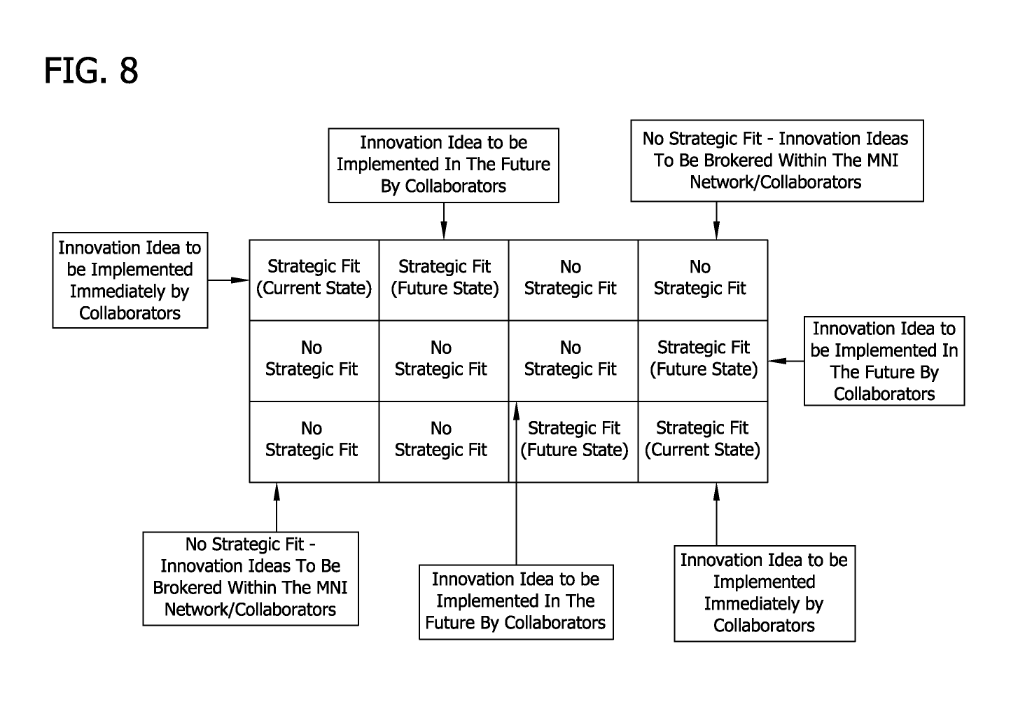

FIG. 8 shows a grid of various collaborative innovations that a company may develop. The grid is used by the company or the system administration to determine whether each or all of the four phases of collaboration process should be applied to a particular innovation. Alternatively, innovations that are not a good fit are brokered, eliminated or placed on “hold.” According to the grid, innovations would fall into three categories and would be subject to applicable different programs. Innovation ideas having a strategic fit with the current state of the company would be in a program which would be implemented immediately internally by collaborators of the company. Innovation ideas having a strategic fit with the future state of the company would be in a program which would be implemented in the future internally by collaborators of the company. Innovation ideas with no strategic fit within the company (either presently or in the future) would be brokered within the system and process for development and implementation by members of the collaborative network. Such brokered ideas may result in residual income to both the company and the system administrator.

The MNI process and system provides members with a unique combination of products and services that address gaps within the Innovation Experience Roadmap and facilitate real-time co-creation of wealth and value. Ultimately, the MNI process and system will be a Virtual Collaborative Innovation Solution for real business members to contribute ideas, jointly develop and evaluate those ideas, reward and recognize the collaborators, and broker and/or market all or some of the innovation ideas.

There are at least four (4) key trends that will provide MNI a business environment for growth and value in the context of the system and process of collaboration. The first trend, Culture of Collaboration, is based on primary and secondary research showing that there is a growing formal desire and practice of developing collaboration networks. The second trend, Business Process, is a real-time, parallel processing, which encompasses 24 work-hours and a requirement for instant feedback or immediacy. The third trend, Mobile and Distributed Resources, is to find the best talent at the best price regardless of geography (location-independence). Finally, the fourth trend, Technology, is based on the convergence of video, voice, and data over the Internet protocol (IP).

“Business-Only” solutions and venues have a main theme which is focused around accessing talented and passionate members in pursuit of achieving key business results.

In “Exclusive Access”, members will be “recognized and rewarded” for their collaboration efforts from submittal, development and through commercialization or implementation of the innovation idea.

Innovation ideas submitted, developed, evaluated and/or implemented within the MNI network will be primarily owned by the innovation idea champion(s) or delegate. However, innovation idea collaborators will be recognized and rewarded relative to their acknowledged contributions and the innovation idea's level of development.

Thus, the MNI process and system provides a secure and virtual collaboration forum where authorized and authenticated members (individual, groups, or corporations) can submit, develop, and evaluate innovation ideas for commercialization or implementation.

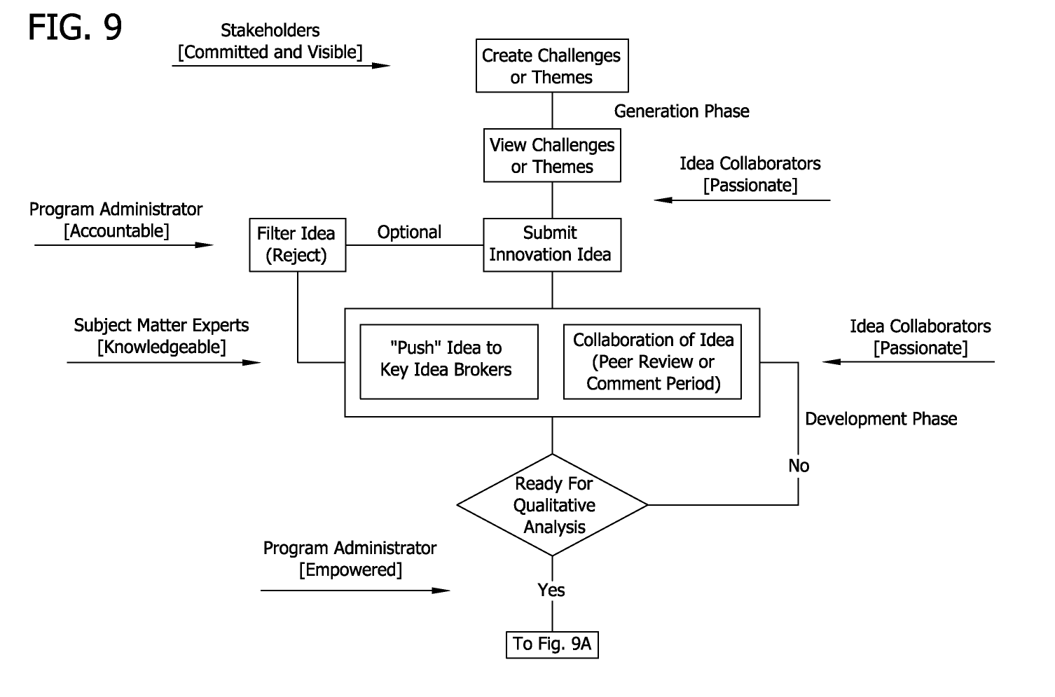

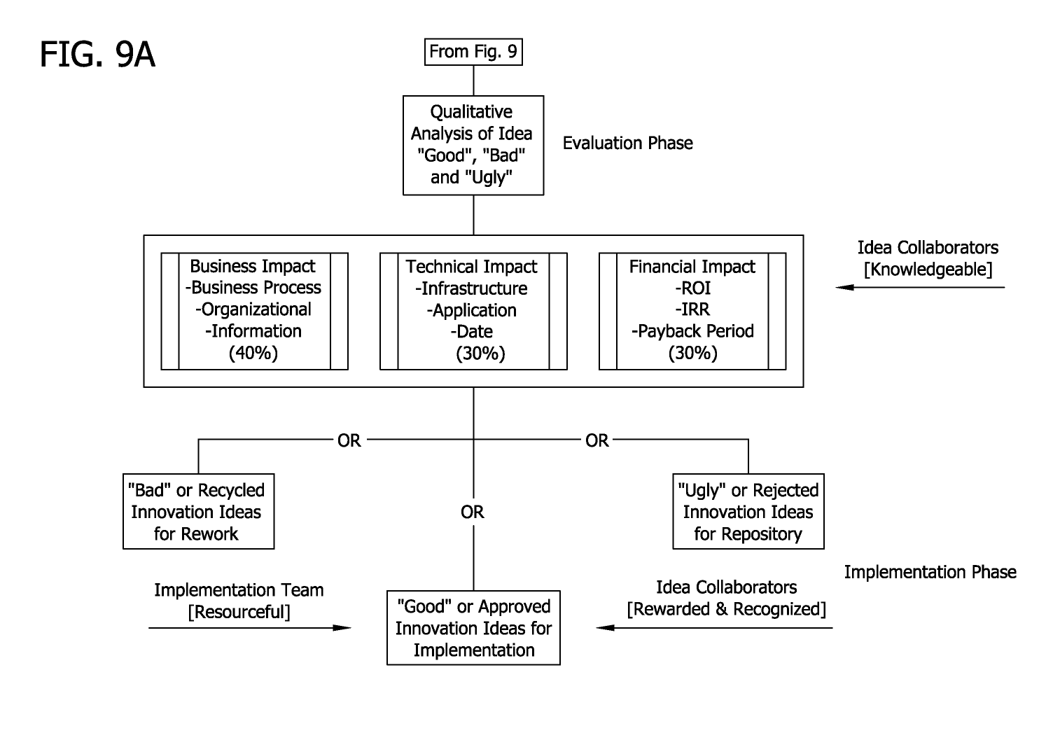

FIGS. 9 and 9A are a flow diagram of the four phase operation of the system and process according to one embodiment of the invention. This is one embodiment of an engagement process for a traditional corporate innovation engagement. Initially, the generation phase would begin with members who are committed and visible stakeholders in the system who would create a challenge or theme for collaboration and post it on the system. Members who are passionate idea collaborators would view the posting and submit an innovation idea in response thereto. At this point, the program administrator may optionally exercise accountability to filter the submitted ideas and reject ideas that are less like to succeed or to reject ideas that are inconsistent or beyond the challenges or theme. This ends the generation phase.

Moving into the development phase, knowledgeable subject matter experts (SMEs) and passionate idea collaborators “push” the idea to key idea brokers and facilitate collaboration of the idea, such as by a peer review or a comment period. Once the idea is ready for qualitative analysis, the development phase ends and the evaluation phase begins. This transition may be implemented by a program administrator empowered to control the process.

The evaluation phase includes a qualitative analysis of the developed ideas. In one embodiment, developed ideas can be simply classified as good (continue with implementation), bad (return to development for more analysis) or ugly (discontinue further efforts). Optionally, the evaluation may include an analysis of the business, technical and/or financial impact. If all three impacts are evaluated, the impacts may be weighted. For example, business impact would affect 40% of the evaluation decision whereas technical impact and financial impact would each affect 30% of the evaluation decision. The resulting impact score could be compared to other impact scores or to a scale or to previous experience to assist in determining whether to proceed with the implementation phase. Ideas which are evaluated as “bad” are recycled. Ideas which are evaluated as “ugly” are rejected. Ideas which are evaluated as “good” are approved and referred to a resourceful implementation team. In addition, idea collaborators of “good” ideas may be rewarded and/or recognized.

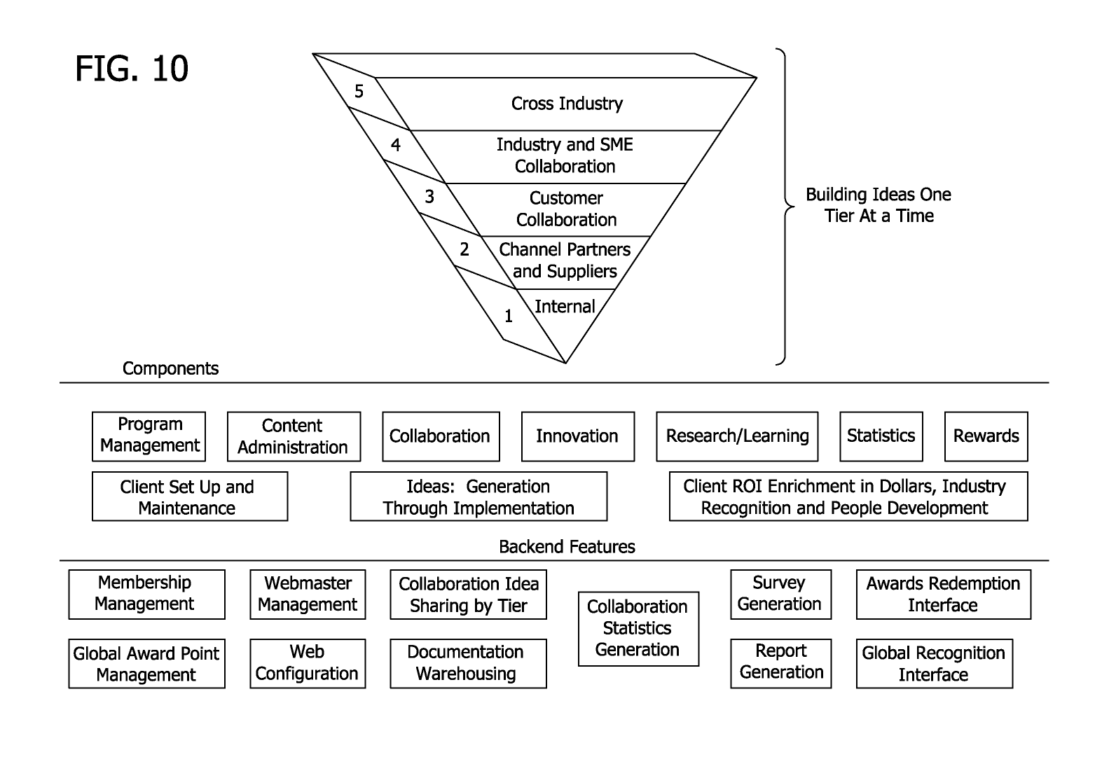

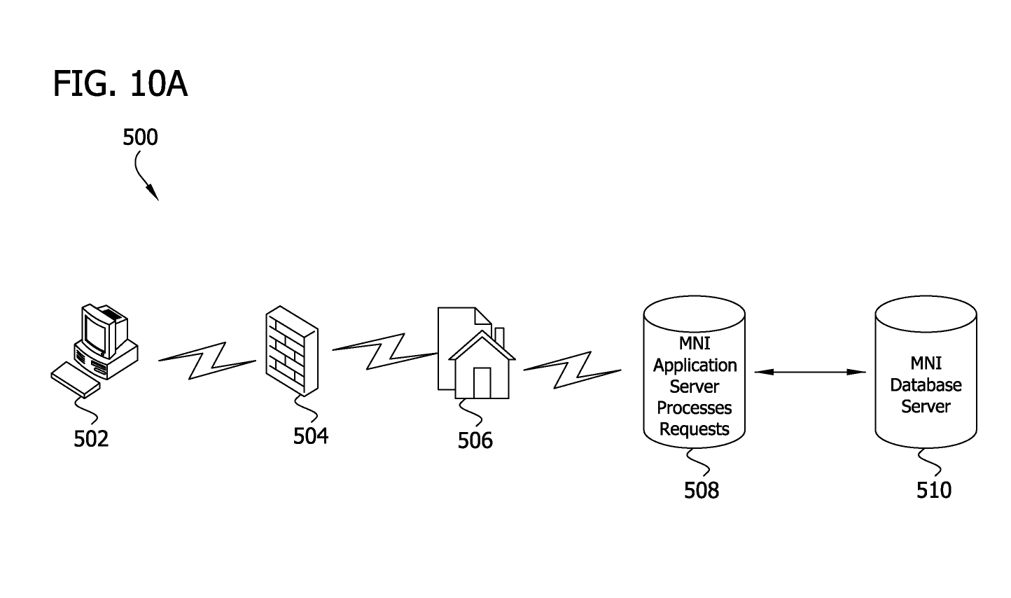

FIG. 10 illustrates one embodiment of the solution of the invention which is based on tiers of members which can be involved one at a time or simultaneously. This illustration shows how the multi-tier “building ideas one-tier at a time” as described in FIG. 1 is supported by the various business layer “components” and “backend features” in order to provide backend administration for ease of client and member setup, collection and dissemination of data, and maintenance of members information. A program management component provides the program administrator with system access to control the process and to make the necessary decisions. A content administration component controls the amount and type of information provided by each tier. Collaboration and innovation components promote involvement of each tier. A research/learning component facilitates the evaluation process and may be part of the evaluation module 430, the learning/training module 460 and/or the research/analysis module 470 (see FIG. 4A). A statistics component keeps track of the numbers for later analysis. A rewards component, at the disposal of the program administrator, provides members with rewards and recognition.

Other optional components include client set up and maintenance, idea generation through implementation and tracking such aspects as client ROI (return on investment), industry recognition and people development. It is also contemplated that one or more backend features may be available to selected program administrators or selected members, including such features as membership management, webmaster management, tier sharing of ideas, statistics and/or survey generation, awards redemption interface (fulfillment), point management, web configuration, document warehousing, report generation and recognition interfacing.

When idea collaboration is tier based, each tier should allow rich collection of data, tier access based on membership level, and selectable tiers so that tiers range from industry wide collaboration down to internal employee collaboration. In order to solidify components, the types and number of components based on budget determines the number of phases for development or evaluation of third party products. Features are evaluated regularly so that features provide the necessary backend administration to allow for ease of client setup, collection and dissemination of data and maintenance of members information.

FIG. 10A illustrates one embodiment of infrastructure for the solution of the invention illustrated in FIG. 10. In conjunction with evaluation of applications to support MNI, the platform allows for growth in service offerings, data warehousing, speed of delivery of reporting and ease of use while being economically feasible for the program owner to support. Using a desktop or other computing device 502, members log into the MNI system 500 and are admitted through a secure firewall 504. As a connected member illustrated by 506, members submit ideas, share challenges and receive information and rewards based on their participation. MNI application servers 508 process various requests to or from members. Multi-tier structured servers 510 may be housed in any of the program owner's in-house servers, such as Oracle/Java/Crystal Records running on Unix/Linux platform or .NET running on a SQL Server (e.g., Brainbank) and interfacing with other applications running on other servers to process requests to/from the MNI system 500.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computers and/or servers may execute the computer-executable instructions such as those illustrated herein to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules on a tangible computer readable storage medium. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and processes without departing from the scope of aspects of the invention, it is intended that all matter contained in the above description and shown in the accompanying drawings shall be interpreted as illustrative and not in a limiting sense.

In view of the above, it will be seen that the several objects of the invention are achieved and other advantageous results attained.

What is claimed is:

1. A system for collaborating members of a network comprising:
a generation module for facilitating the submission of ideas by the members of the network;
a development module for facilitating the members of the network to provide input to develop the ideas submitted via the generation module;
an evaluation module for facilitating the members of the network to provide input to evaluate the ideas developed via the development module; and
an implementation module for facilitating the members of the network to implement the ideas evaluated via the evaluation module.

2. The system of claim 1 further comprising a learning/training module providing learning or training in a technology relating to the idea.

3. The system of claim 3 further comprising a research/analysis module including at least one of technology services relating to the idea being collaborated, analytics relating to the idea being collaborated, business intelligence relating to the idea being collaborated and research relating to the idea being collaborated.

4. The system of claim 1 further comprising a rewards or recognition module for rewarding or recognizing a member.

5. The system of claim 1 wherein the implementation module includes a module for:
withdrawing evaluated ideas;
executing evaluated ideas;
providing broker services for the evaluated ideas; and/or
providing intermediary services for the evaluated ideas.

6. The system of claim 1 wherein the implementation module includes targeted innovation and/or collaborative innovation.

7. The system of claim 1 wherein the modules permit members to set, re-set, and/or extend collaboration of their ideas to their value chain, including at least one of customers, channel partners, individuals, companies, facilities and/or suppliers, industry, subject matter experts (SME), and across industries.

8. The system of claim 1 wherein the evaluation module includes a module for collaborating by the members with regard to the developed ideas; a module for qualifying the evaluated ideas by the members; and a module for assigning value to the qualified ideas by the members.

9. The system of claim 1 wherein the members include channel partners, suppliers, customers, industry representatives, individuals, companies, facilities, subject matter experts and cross industry representatives, each of which is independent and distinct from the others, each of which operates independently of the others and each of which has a unique skill set as compared to the skill set of the others.

10. A process for collaborating members of a network comprising the phases of:
submitting ideas by the members of the network;
developing by the members of the submitted ideas;
evaluating by the members the developed ideas including:
collaborating by the members with regard to the developed ideas;
qualifying the evaluated ideas by the members;
assigning value to the qualified ideas by the members; and
implementing by at least one of the members the evaluated ideas.

11. The process of claim 10 further comprising member profiling based on at least one of rational member characteristics, irrational member characteristics and identifying key facilitators of ideas.

12. The process of claim 11 wherein the profiling includes identifying internal and functional collaborators, channel partners, individuals, companies, facilities and supplier collaborators to enable the efficient and targeted collaboration of ideas.

13. The process of claim 10 wherein the members set, re-set, and/or extend collaboration of their ideas to their value chain including at least one of customers, channel partners, individuals, companies, facilities and/or suppliers, industry, subject matter experts (SME), and across industries.

14. The process of claim 10 further comprising:
facilitating the submission of ideas by the members of the network;
facilitating the members of the network to provide input to develop the ideas submitted via the generation module;
facilitating the members of the network to provide input to evaluate the ideas developed via the development module; and
facilitating the members of the network to implement the ideas evaluated via the evaluation module.

15. The process of claim 14 further comprising:
providing learning or training in a technology relating to the idea.

16. The process of claim 14 further comprising: at least one of technology services relating to the idea being collaborated, analytics relating to the idea being collaborated, business intelligence relating to the idea being collaborated and research relating to the idea being collaborated.

17. The process of claim 14 further comprising:
rewarding or recognizing a member.

18. The process of claim 14 further comprising:
withdrawing evaluated ideas;
executing evaluated ideas;
providing broker services for the evaluated ideas; and/or
providing intermediary services for the evaluated ideas.

19. The process of claim 14 further comprising:
evaluating by the members with regard to the developed ideas; qualifying the evaluated ideas by the members; and
assigning value to the qualified ideas by the members.

20. The method of claim 10 wherein the members include channel partners, suppliers, customers, industry representatives, individuals, companies, facilities, subject matter experts and cross industry representatives, each of which is independent and distinct from the others, each of which operates independently of the others and each of which has a unique skill set as compared to the skill set of the others.
